(19) United States
(12) Patent Application Publication
(10) Pub. No.: US 2011/0036829 A1
(43) Pub. Date: Feb. 17, 2011

(54) PLANAR HEATING ELEMENT OBTAINED USING DISPERSION OF FINE CARBON FIBERS IN WATER AND PROCESS FOR PRODUCING THE PLANAR HEATING ELEMENT

(75) Inventors: Bunshi Fugetsu, Hokkaido (JP); Naohiro Tarumoto, Tokyo (JP); Yasuhito Yano, Tokyo (JP); Jun Suzuki, Tokyo (JP); Takayuki Tsukada, Tokyo (JP); Fuminori Munekane, Tokyo (JP)

Correspondence Address: GREENBLUM & BERNSTEIN, P.L.C., 1950 ROLAND CLARKE PLACE, RESTON, VA, 20191, US

(73) Assignees: HODOGAYA CHEMICAL CO., LTD., Tokyo (JP); NATIONAL UNIVERSITY CORPORATION HOKKAIDO UNIVERSITY, Hokkaido (JP)

(21) Appl. No.: 12/810,901

(22) PCT Filed: Dec. 25, 2008
(86) PCT No.: PCT/JP2008/073628

§ 371 Date: Nov. 2, 2010

(30) Foreign Application Priority Data
Dec. 26, 2007 (JP) 2007-333547

(51) Int. Cl. H05B 3/14; H05B 3/20; H05B 3/03; H01C 17/06

(52) U.S. Cl. 219/541; 219/543; 219/553; 29/611; 29/620

(57) ABSTRACT

[Problems] To produce planar heating elements having high exothermic efficiency and provide energy-saving electric carpets, floor heating, wall surface heating appliances and heaters for thawing on roads and/or roofs or antifogging for mirrors.

[Means for Solving] To provide a planar heating element produced by applying, to an insulating substrate or the like, an electrically conductive fine carbon fiber film that is fabricated using an aqueous dispersion of fine carbon fibers in which the fine carbon fibers are evenly dispersed in an aqueous solution.

### TECHNICAL FIELD

The present invention relates to a planar heating element having, as a planar heating layer, an electrically conductive fine carbon fiber film obtained using an aqueous dispersion of fine carbon fibers and a process for producing the planar heating element, and can be used, for example, as a heating source for electric carpets, floor heating, wall surface heating appliances, heaters for thawing on roads and/or roofs or antifogging for mirrors or heaters to be used for heating and insulation of pipelines and the like.

### BACKGROUND ART

Traditionally, planar heating elements intended for floor heating, road thawing and the like were made of thermoplastic resins such as ethylene-ethyl acrylate copolymer (EEA) that were incorporated with electrically conductive particles such as carbon black to produce exothermic compositions which were then molded into sheets to form planar heating plates, to which electrodes were attached, and were designed so that when an electric current is applied between the electrodes, the planar heating layers may generate heat due to Joule heat.

These planar heating elements dissipate heat in two directions from the front and back face in their central region. At the both ends, as heat is dissipated in three directions including from the side in addition to the front and back faces, the central region tends to be higher in temperature than the both end regions. Due to such tendency, for planar heating layers having positive temperature coefficient characteristics (hereafter abbreviated as PTC characteristics) in which specific resistance increases in accordance with an increase in temperature, local heating may occur in which the temperature at the central region may become excessively higher than the temperatures at the both ends, making even temperature control difficult.

As such, when multiple planar heating elements are positioned at a predetermined spacing from each other to provide floor heating, the temperature above a place between planar heating elements is lower than the temperature right above the planar heating element. In order to avoid such local heat generation and temperature unevenness, traditionally, planar heating elements are fitted with heat-equalizing plates consisting of aluminum plates (for example, Patent Reference 1), planar heating elements are varied in thickness to equalize specific resistances of various regions (for example, Patent Reference 2) and so on.

However, during production of planar heating elements, there are problems; heat-equalizing plates having a predetermined thickness must be adhered to either the front or back face of the planar heating elements, and as a result, the production processes are complex, the adhering operations are messy, and the production cost is elevated. Also, if the heat-equalizing plates are not laminated on the whole surface of planar heating layers, creating portions where the planar heating layers are exposed, a difference in temperature may arise between the exposed portions and the heat-equalizing plates. Moreover, these techniques go only as far as to equalize specific resistances of various regions, failing to sufficiently preventing local heat generation caused by a difference in the amount of heat dissipated between the various regions. Furthermore, when thicknesses of the planar heating elements are varied to equalize specific resistances of various regions, a gradient in thickness distribution occurs, creating inconveniences. Also, when carbon black is used as electrically conductive particles, a large amount of carbon black is needed to obtain desired electrical conductivity, therefore, in often the cases, degrading characteristics inherent to resins to be used for the heating layers (for example, Patent References 3 and 4).

On the other hand, the carbon nanotube discovered in 1976 is a tubular material having a diameter of 100 nm or smaller. An ideal one may form a tube in which the planes of a hexagonal carbon network are parallel to the axis of the tube and, further, the tube may have two, three, four or more layers. The carbon nanotubes have different properties depending on the number of hexagonal carbon networks and/or the thickness of the tubes. As such, it is expected that their physical properties such as chemical characteristics, electrical characteristics, mechanical characteristics, electrical conductivity and structural characteristics may be utilized in applications to electronic devices, electrical wiring, electrothermal conversion device materials, thermoelectric conversion device materials, heat-dissipating materials for use in building materials, electromagnetic wave shield materials, radio wave absorption materials, field emission cathode materials for use in flat panel displays, electrode bonding materials, resin composite materials, transparent conductive films, catalyst carrier materials, electrode and hydrogen storage materials, reinforcement materials, black pigments and the like.

In order to solve the problems associated with planar heating elements, therefore, planar heating elements incorporating carbon nanotubes in place of carbon black as electrically conductive particles in binder resins (for example, Patent References 5, 6, 7 and 8), planar heating elements including carbon nanotubes and electrically conductive metal compounds or filamentous metal fine particles admixed to be incorporated in binder resins (for example, Patent References 9 and 10) and the like have been reported. Also, application of thin film resistive heating elements using carbon nanotubes to heating and fixing members for toners (for example, Patent Reference 11), and the like have been reported.

In fabricating planar heating layers to be used for planar heating elements, however, when binder resins are thermoplastic resins, film thinning is difficult. Also, after fabricating carbon nanotube/resin composites using a kneader or the like, planar heating plates must be fabricated using an injection molding machine or the like according to a compression, casting, injection, extrusion or drawing method, requiring a number of steps and a large amount of time before production. Further, in order to fabricate carbon nanotube-containing resin plates having a desired low resistance, a large amount of carbon nanotubes is needed, increasing the material cost. Also, in the state of the art, fabricating resin plates of carbon nanotube/resin composites with a precisely controlled resistance required by planar heating elements is highly difficult. When a thermosetting resin is used as a binder resin, since a dispersion which tends to disperse carbon nanotubes during a stage before setting is a highly viscous paste, a dispersion in which carbon nanotube aggregates or carbon nanotubes formed into bundled structures are less in proportion is difficult to fabricate. Therefore, the carbon nanotubes may not evenly be dispersed within or on the surface of planar heating plates after setting, which makes it unable to provide uniform temperature control as planar heating elements. Also, with respect to fabrication of planar heating elements in which carbon nanotubes and electrically conductive metal compounds or filamentous metal particles are admixed as electrically conductive particles of the planar heating elements, it is highly difficult to evenly disperse the electrically conductive particles having largely different specific gravities across planar heating layers.

In order to stably produce planar heating elements using carbon nanotubes, therefore, it is important for the carbon nanotubes to be evenly dispersed, and techniques capable of stably producing them are important.

However, the carbon nanotubes have very strong interfiber cohesion (van der Waals force) as their characteristics and, therefore, they tend to aggregate with each other while in mixture with an aqueous solution, an organic solvent, a resin solution or a resin, making it difficult to produce a solution, a resin solution or a resin in which the carbon nanotubes are sufficiently dispersed, in the state of the art. This is due to the fact that the smooth surface of the carbon nanotubes at atomic level tend to greatly reduce the affinity toward the resin solution.

Therefore, although the carbon nanotubes have specific and useful properties, the production of aqueous solutions, dispersions in organic solvents or resin solutions, polymer-based nanocomposites and the like in which the carbon nanotubes are evenly dispersed is extremely difficult, making it in effect difficult to practically apply them in various uses. A number of trials for improvement as reported below are now described.

It has been disclosed that water-soluble solvents and/or organic solvents or mixtures thereof are usable as dispersion solvents for carbon nanotubes. Examples include water, acidic solutions, alkaline solutions, alcohols, diethyl ether, petroleum ether, benzene, ethyl acetate, chloroform, isopropyl alcohol, ethanol, acetone, and toluene (refer to Patent Reference 12, for example).

Also, a method for dispersing carbon nanotubes in a combined solvent of N-methylpyrrolidone as an amide-based polar organic solvent and polyvinyl pyrrolidone as a polymer solvent has been disclosed (refer to Patent Reference 13, for example). Further, a method for dispersing carbon nanotubes using a polyesterate amideamine salt as a basic macromolecule in a hydrocarbon-based solvent has been disclosed (refer to Patent Reference 14, for example).

The solutions of dispersed carbon nanotubes obtained according to the method described above have the carbon nanotubes well dispersed as aggregates, however, many of which are not split. Also, when solutions of carbon nanotubes dispersed in organic solvents are used for carrying out film production, organic solvent volatiles as VOC components are generated in the production steps, hardly enabling it to be referred to as a new technique with consideration on the environment.

Therefore, attention is focused on techniques using water as a solvent for evenly dispersing carbon nanotubes. For aqueous dispersions of carbon nanotubes, a method for dispersing carbon nanotubes using a nonionic surfactant is also disclosed. Tergitol™ NP7 is used as the nonionic surfactant, it has been reported that when the amount of incorporated carbon nanotubes increases, the carbon nanotubes tend to aggregate, preventing an even dispersion from being obtained (refer to Non-patent Reference 1, for example). It has also been reported that by ultrasonicating single-layer carbon nanotubes in an aqueous solution of an anionic surfactant SDS, the hydrophobic surface of the carbon nanotubes and the hydrophobic portions of the surfactant are adsorbed to form hydrophillic portions on the outside so that the carbon nanotubes may be dispersed in water (refer to Non-Patent Reference 2, for example).

These conventional physical methods for dispersion, such as ultrasonication suffer from the problem that long time is needed to disperse carbon nanotubes. This problem is true of nonionic and anionic surfactants or the like. That is, those substances used for increasing affinity with solvents, such as nonionic and anionic surfactants, are not capable of dispersing bundled structures of carbon nanotubes, by themselves. Also, methods using repulsive force of molecules having the same polarity need ultrasonication, and it may be said that these molecules only prevent dispersed carbon nanotubes from reaggregating, rather than dispersing bundles. Also, the obtained aqueous solution of carbon dispersed contains, in mixture with isolated and dispersed carbon nanotubes, aggregates of carbon nanotubes and bundled forms of carbon nanotubes, which need separation and purification. In order to separate and purify the aggregates of carbon nanotubes and the bundled forms of carbon nanotubes described above from the aqueous dispersion of carbon nanotubes, a high-performance centrifugal separator is required, and the separation step requires more time and equipment.

As a technique that has successfully solved the problems in fabricating aqueous dispersions of carbon nanotubes described above, a method for dispersing carbon nanotubes in water with the use of ampholytic surfactants, utilizing electrical repulsive force between ampholytic molecules, is found (for example, Patent References 15, 16, and 17). Specifically, aqueous dispersions of carbon nanotubes in which the carbon nanotubes are stably and evenly dispersed are fabricated by attaching the ampholytic molecules to some of the carbon nanotubes having highly strong interfiber cohesion (van der Waals force) and, optionally, formed into multiple bundles of carbon nanotubes and, from the multiple aggregates and bundles, isolating and dispersing those carbon nanotubes that compose the multiple bundles of carbon nanotubes through repulsive and attractive forces between the ampholytic molecules attached to those carbon nanotubes that compose some of the bundles of carbon nanotubes and the ampholytic molecules attached to those carbon nanotubes that compose adjacent other bundles of carbon nanotubes.

There is, however, no detailed report on applied techniques utilizing chemical characteristics, electrical characteristics, mechanical characteristics, thermal conductivity, structural characteristics and the like unique to carbon nanotubes, by using the aqueous dispersion of carbon nanotubes described above in which the carbon nanotubes are evenly dispersed. Also, planar heating elements using as planar heating layers electrically conductive carbon nanotube films obtained using an aqueous dispersion of carbon nanotubes or techniques for simplification of production steps by using an aqueous dispersion of carbon nanotubes have not sufficiently been established yet.

Patent Reference 1: Japanese Unexamined Patent Publication 2005-11651

Patent Reference 2: Japanese Unexamined Patent Publication Hei 1-151191

Patent Reference 3: Japanese Unexamined Patent

Publication Hei 8-264268

Patent Reference 4: Japanese Unexamined Patent Publication 2006-202575

Patent Reference 5: Japanese Unexamined Patent Publication 2003-163104

Patent Reference 6: Japanese Unexamined Patent Publication 2007-109640

Patent Reference 7: Japanese Unexamined Patent Publication 2000-058228

Patent Reference 8: Japanese Unexamined Patent Publication 2002-075602

Patent Reference 9: Japanese Unexamined Patent Publication 2000-026760

Patent Reference 10: Japanese Unexamined Patent Publication 2004-103766

Patent Reference 11: Japanese Unexamined Patent Publication 2007-092234

Patent Reference 12: Japanese Unexamined Patent Publication 2000-72420

Patent Reference 13: Japanese Unexamined Patent Publication 2005-162877

Patent Reference 14: Japanese Unexamined Patent Publication 2006-63436

Patent Reference 15: Japanese Unexamined Patent Publication 2007-39623

Patent Reference 16: WO2004/060798

Patent Reference 17: Japanese Unexamined Patent Publication 2007-182363

Non-patent Reference 1: S. Cui et al. Carbon 41, 2003, 797-809

Non-patent Reference 2: Michael, J. O'Connel et al. SCIENCE Vol. 297, 26, July 2002, 593-596

### DISCLOSURE OF THE INVENTION

### Problems to be Solved by the Invention

The present invention aims to provide a planar heating element which is made by using an aqueous dispersion of fine carbon fibers in which the fine carbon fibers having incomparably high cohesion are dispersed in an aqueous solution in a uniform manner, to fabricate an electrically conductive fine carbon fiber film, which is then applied to a heating layer, and to provide a process for producing the planar heating element.

### Means for Solving the Problems

In order to solve the above problems, as a result of energetic studies, the inventors have found a planar heating element using, as a heating layer, an electrically conductive fine carbon fiber film obtained using an aqueous dispersion of fine carbon fibers, to accomplish the present invention. Specifically, the present invention is composed as follows.

A planar heating element obtained using an aqueous dispersion of fine carbon fibers.

The planar heating element obtained by applying the aqueous dispersion of fine carbon fibers to a substrate surface and drying the dispersion.

The planar heating element, wherein the aqueous dispersion of fine carbon fibers contains an ampholytic surfactant.

The planar heating element, wherein the aqueous dispersion of fine carbon fibers includes a ampholytic surfactant and a dispersion stabilizer added thereto.

The planar heating element, wherein the ampholytic surfactant contains an ampholytic hydrophillic group which is a sulfobetaine skeleton.

The planar heating element, wherein the ampholytic surfactant is one or more selected from 3-(N,N-dimethylstearylammonio)propanesulfonate, 3-(N,N-dimethylmyristylammonio)propanesulfonate, 3-[(3-cholamidepropyl)dimethylammonio]-2-hydroxypropanesulfonate, n-hexadecyl-N and N′-dimethyl-3-ammonio-1-propanesulfonate.

The planar heating element, wherein the dispersion stabilizer is one or more selected from a low-molecular weight compound having an amino group or a hydroxyl group, an oligomer having an amino group or a hydroxyl group, and a water-soluble macromolecule having an amino group or a hydroxyl group.

The planar heating element, wherein the dispersion stabilizer is sugar alcohol, glycerol, higher alcohol or polyvinyl alcohol.

The planar heating element, wherein the fine carbon fibers are composed of fine carbon fibers having an outer diameter of 0.5 to 800 nm.

The planar heating element, wherein the fine carbon fibers are single-layer, two-layer, three-layer, four-layer or multi-layer carbon nanotubes.

The planar heating element, wherein the fine carbon fibers are networked carbon nanotube structures composed of carbon nanotubes having an outer diameter of 15 to 100 nm, the carbon nanotube structures being embodied as the carbon nanotubes extending in plurality, having granular portions for linking the carbon nanotubes with each other, the granular portions formed in the process of carbon nanotube growth, having a size 1.3 times or larger than the outer shape of the carbon nanotubes and having an I_{D}/I_{G} of 0.1 or smaller as determined by Raman spectroscopy at 514 nm.

The planar heating element, wherein the multi-layer carbon nanotubes used are high in purity having a tar content of 0.5% or less.

The planar heating element, wherein the aqueous dispersion of fine carbon fiber contains the carbon nanotubes at a mass ratio of 0.01 to 30%.

The planar heating element, wherein an electrically conductive fine carbon fiber film obtained using the aqueous dispersion of fine carbon fibers constitutes a planar heating layer.

The planar heating element, wherein the planar heating layer has a thickness of 0.4 mm or smaller.

The planar heating element, wherein the planar heating layer has a resistance between electrodes of 300Ω or lower.

The planar heating element, wherein the electrodes are provided only at the both ends of the planar heating layer.

The planar heating element, wherein the planar heating layer does not exhibit PTC characteristics.

The planar heating element, composed of an electrically conductive fine carbon fiber film obtained using an aqueous dispersion of fine carbon fibers on an insulating substrate and electrodes.

The planar heating element, composed of an electrically conductive fine carbon fiber films obtained using an aqueous dispersion of fine carbon fibers on an insulating substrate, electrodes and an insulating substrate coating the electrodes.

A process for producing planar heating elements, comprising an application step of applying an aqueous dispersion of fine carbon fibers to a surface of an insulating substrate, a planar heating layer forming step of drying the aqueous dispersion of fine carbon fibers applied on the insulating substrate to form a planar heating layer, and an electrode forming step of forming electrodes on the planar heating layer.

The process for producing planar heating elements, comprising an application step of applying an aqueous dispersion of fine carbon fibers to a surface of an insulating substrate, a planar heating layer forming step of drying the aqueous dispersion of fine carbon fibers applied on the insulating substrate to form a planar heating layer, an electrode forming step of forming electrodes on the planar heating layer, and an insulating layer forming step of coating the heating layer and the electrodes.

### EFFECT OF THE INVENTION

Since the planar heating element according to the present invention applies an electrically conductive fine carbon fiber film obtained using an aqueous dispersion of fine carbon fibers in which the fine carbon fibers are evenly dispersed to planar heating layer, the fine carbon fibers are evenly present on the whole surface, therefore enabling to easily fabricate a planar heating element with less local heat generation. Also, since the planar heating element does not exhibit PTC characteristics, heat-equalizing plates are not needed unlike a planar heating element utilizing PTC characteristics, therefore enabling to simplify production steps. Further, since the aqueous dispersion of carbon nanotubes is used in fabricating the planar heating layer of the planar heating element, VOC components are not generated in production steps, enabling it to be referred to as an environment-conscious technique with consideration on the environment. Further, when carbon nanotubes lower in tar content are used, products safer to the human body may be provided in situations where they are used as planar heating element products.

### BEST MODE FOR CARRYING OUT THE INVENTION

The present invention is described in detail below. In the fine carbon fibers according to the present invention, single-layer, two-layer, three-layer, four-layer and multi-layer carbon nanotubes are shown and can be used according to the intended purposes. According to the present invention, more preferably, multi-layer carbon nanotubes are used. Processes for producing carbon nanotubes are particularly limited and any of conventionally known processes for production, such as a vapor phase growth method using catalysts, an arc discharge method, a laser vapor deposition method and a HiPco method (High-pressure carbon monoxide process) may be used.

For example, a process for fabricating single-layer carbon nanotubes according to the laser vapor deposition method is described below. A mixed lot of graphite powder and nickel and cobalt fine powders was provided as the raw material. The mixed lot can be heated under argon atmosphere at 665 hPa (500 Torr) by an electric furnace to 1250° C., which is irradiated with pulses of second harmonics of an Nd:YAG laser at 350 mJ/pulse to evaporate carbon and metal fine particles, thereby to produce single-layer carbon nanotubes.

The process for fabrication described above is only a typical example, and the type of metals, the type of gases, the temperature of a furnace, the wavelength of a laser and the like may be modified. Also, single-layer carbon nanotubes fabricated by processes other than the laser vapor deposition method, for example, a HiPco method, a vapor phase growth method, an arc discharge method, a thermal decomposition method of carbon monoxide, a template method in which organic molecules are inserted in fine pores for thermal decomposition, a codeposition method of fullerene and metals and other methods, may be used.

For example, a process for fabricating two-layer carbon nanotubes by a constant-temperature arc discharge method is described below. A surface-treated Si substrate was used as the substrate. Alumina powder was immersed for 30 minutes in a solution in which catalyst metals and cocatalyst metals are dissolved and were further ultrasonicated for three hours for dispersion. The obtained solution was applied to the Si substrate and maintained and dried in air at 120° C. The substrate was placed in a reaction chamber of a carbon nanotube production apparatus, using a mixture of hydrogen and methane as reaction gas, with feed rates of gases at 50 sccm for hydrogen and 10 sccm for methane and a pressure in the reaction chamber at 70 Torr. A bar-like discharge part consisting of Ta was used as the cathode part. Next, A DC voltage was applied across the anode and cathode parts and across the anode part and the substrate and the discharge voltage was controlled so that it may remain constant at 2.5 A. When the temperature of the cathode part reached 2300° C. through discharge, a normal glow discharge state turns into an abnormal glow discharge state. A discharge current of 2.5 A, a discharge voltage of 700 V and a reaction gas temperature of 3000° C. may be provided for 10 minutes to produce single-layer and two-layer carbon nanotubes over the whole substrate.

The process for fabrication described above is intended just as an example, and various conditions such as type of metals and type of gas may be modified. Also, single-layer carbon nanotubes fabricated by processes other than the arc discharge method may be used.

For example, a process for fabricating multi-layer carbon nanotubes having a three-dimensional structure by a vapor phase growth method is described below. Basically, using ultrafine transition metal particles as a catalyst, organic compounds such as hydrocarbons can be chemically and thermally decomposed by a CVD method to obtain fiber structures (hereafter, intermediate), which are further heat-treated at an elevated temperature to fabricate multi-layer carbon nanotubes.

As raw material organic compounds, hydrocarbons such as benzene, toluene and xylenes, carbon monoxide and alcohols such as ethanol are used. It is preferred to use at least two carbonaceous compounds having different decomposition temperatures as carbon sources. Use of at least two carbonaceous compounds does not necessarily mean that two or more raw material organic compounds are used; rather, it includes embodiments such that, although a single raw material organic compound is used, at a process for synthesizing fiber structures, it may undergo a reaction such as hydrogen dealkylation of toluene and/or xylenes to be turned into two or more carbonaceous compounds having different decomposition temperatures in a subsequent thermal decomposition reaction system. As atmosphere gases, inert gases such as argon, helium and xenon are used and as catalysts, mixtures of transition metals such as iron, cobalt and molybdenum or transition metal compounds such as ferrocene and metal acetates and sulfur or sulfur compounds such as thiophene and iron sulfide are used.

Synthesis of the intermediate may be carried out using a usually practiced CVD method of hydrocarbons, in which a mixed liquid of hydrocarbons as raw materials and catalysts is evaporated and, using hydrogen gas or the like as a carrier gas, introduced into a reaction furnace to be thermally decomposed at a temperature of 800 to 1300° C. Thereby, aggregates centimeters to tens of centimeters in size, which consist of multiple carbon nanotube structures (intermediate) having a sparse three-dimensional structure made of fibers 15 to 100 nm in outer diameter that are linked to each other by granulates grown based on the catalyst particles as nuclei, are synthesized.

The thermal decomposition reaction of the hydrocarbons as raw materials mainly occurs on the surface of the catalyst particles or the granulates grown based on them as nuclei and growth occurs in a fiber-creating manner as recrystallization of carbon generated by the decomposition proceeds unidirectionally from the catalyst particles or the granulates. However, the balance between the thermal decomposition rate and the growth rate is intentionally altered. For example, using at least two carbonaceous compounds having different decomposition temperatures as carbon sources as described above, the carbonaceous substances may grow in a three-dimensional manner about the granulates, rather than growing in one-dimensional directions. Naturally, such three-dimensional growth of carbon nanotubes does not depend only on the balance between the thermal decomposition rate and the growth rate, but are also influenced by the crystal face selectivity, the residence time in the furnace, the temperature distribution in the furnace and the like. In general, however, when the growth rate is higher than the thermal decomposition rate, the carbonaceous substances grow in a fiber-creating manner; on the other hand, when the thermal decomposition rate is higher than the growth rate, the carbonaceous substances grow in a direction circumferential to the surface of catalyst particles. Thus, by intentionally altering the balance between the thermal decomposition rate and the growth rate, the growth of the carbonaceous substance described above may be controllably turned to other directions, rather than being unidirectional, to form three-dimensional structures. It is preferred in the generated intermediate that the composition of the catalysts or the like, the residence time in the furnace, the reaction temperature and the gas temperature and the like are optimized so that the three-dimensional structures as described above in which the fibers are linked with each other by the granulates may easily be formed.

The intermediate obtained by heating the mixed gas of catalysts and hydrocarbons at a constant temperature in the range of 800 to 1300° C. possesses such a structure that is composed of laminated patch-like sheets consisting of carbon atoms, shows a very large D band as examined by Raman spectroscopy and suffers a large number of defects. The grown intermediate contains unreacted raw materials, non-fibrous carbonaceous matters, tar and catalyst metals.

In order to remove such residues from the intermediate and obtain intended carbon nanotubes with less defects, therefore, a heat treatment at an elevated temperature of 1500 to 3000° C. is carried out in an appropriate manner.

Specifically, for example, the intermediate is heated at 800 to 1300° C. to remove unreacted raw materials and tar and then annealed at an elevated temperature of 1500 to 3000° C. to prepare intended structures and, at the same time, evaporate and remove the catalyst metals contained in the fibers. In so doing, in order to protect the substance structures, a reducing gas or a slight amount of carbon monoxide may be added to the inert gas atmosphere.

When the intermediate is annealed at a temperature in the range of 1500 to 3000° C., the patch-like sheets consisting of carbon atoms link with each other to form multiple graphene sheet-like layers.

In producing the planar heating element according to the present invention, it is preferred to use carbon nanotubes having a tar content of 0.5% or less. In producing or heating the planar heating element, when carbon nanotubes having less impurities such as tar are used, the emission of volatile organic compounds (VOC) may be reduced, giving convenience in health and/or the environment. To that end, carbon nanotubes annealed at the temperature conditions described above may be utilized.

In producing the present heating element, such setting may be made that PTC characteristics may not be given, if necessary. PTC functions are derived from the fact that coefficients of thermal expansion of various electrically conductive fillers are much smaller than those of resins for immobilization, and caused by the resins between the electrically conductive fillers expanding due to heating and pulling the electrically conductive fillers away. As such, for development of self-control functions, the contact and detachment of the electrically conductive fillers have always been involved, therefore easily causing contact breakdown, during which microcurrent would cause partial carbonization of the resins, with a possible danger of inflammation. The present technique can produce heating layers without addition of binder resins and design planar heating elements suited for intended uses. Dispersion stabilizers may not be added for short-term storage of aqueous dispersions of fine carbon fibers.

Also, before or after such heat treatment at an elevated temperature, carbon nanotubes having desired circle-equivalent average diameters are fabricated through a step of granulating the circle-equivalent average diameter of carbon nanotube structures down to centimeters and a step of pulverizing the circle-equivalent average diameter of the granulated carbon nanotube structures down to 50 to 100 μm.

The process for fabrication described above is intended just as an example, and various conditions such as type of metals and type of gases may be modified. Also, multi-layer carbon nanotubes fabricated by processes other than the vapor phase growth method may be used.

The content of the fine carbon fibers in the aqueous dispersion of fine carbon fibers according to the present invention is in the range of 0.01 to 30% by mass, preferably in the range of 0.05 to 20% by mass, and more preferably in the range of 0.1 to 15% by mass. Thus, when the fine carbon fibers are less than 0.01% by mass, desired electrical conductivity may not easily be obtained. When the carbon fibers are more than 30% by mass, the fine carbon fibers are so bulky that low-viscosity aqueous dispersions of fine carbon fibers may not be fabricated.

Examples of ampholytic surfactants are described below, but the present invention is not limited thereto. Examples of ampholytic surfactants may include phosphatidylcholine-based ampholytic surfactants, such as distearoylphosphatidylcholine, dimyristoylphosphatidylcholine, dipalmitoylphosphatidylcholine, phosphatidylethanolamine, phosphatidylinositol, phosphatidylserine, phosphatidylglycerol, diphosphatidylglycerol, lysophosphatidylcholine, sphingomyelin, n-octylphoshocholine, n-dodecylphosphocholine, n-tetradecylphosphocholine and n-hexadecylphosphocholine, and sulfobetaine-based ampholytic surfactants, such as 3-(N,N-dimethylstearylammonio)propanesulfonate, 3-(N,N-dimethylmyristylammonio)propanesulfonate, 3-[(3-cholamidopropyl)dimethylamino]propanesulfonic acid, 3-[(3-cholamidopropyl)dimethylammonio]-2-hydroxy-propanesulfonate and n-hexadecyl-N,NT-dimethyl-3-ammonio-1-propanesulfonate. Other ampholytic surfactants may include 3-[(3-cholamidopropyl)dimethylamino]-2-hydroxy-1-propanesulfonate, hydroxysulfobetaine-based surfactants, such as that available under the tradename Anhitol 20 HD (Kao Corporation), carboxybetaine-based surfactants, such as those available under the tradenames Anhitol 20 BS, 24 B and 86 B (Kao Corporation) and NISSANANON BDC-SF, BDF-R, BDF-SF, BDL-SF, BF, BL and BL-SF (NOF Corporation), amidobetaine-based surfactants, such as those available under the tradenames Anhitol 20 AD and 55 AB (Kao Corporation), amineoxide-based surfactants, such as that available under the tradename Anhitol 20 N (Kao Corporation) and imidazolium-based surfactants, such as those available under the tradenames Anhitol 20 YB (Kao Corporation) and NISSANANON GLM-R and GLM-R-LV (NOF Corporation).

The content of surfactants in the aqeuous dispersion of fine carbon fibers according to the present invention is in the range of 0.001 to 50% by mass, preferably in the range of 0.005 to 40% by mass, and more preferably in the range of 0.01 to 30% by mass. Thus, when the surfactants are less than 0.001% by mass, desired dispersed state may not be obtained. Also, when the surfactants are more than 50% by mass, the surfactants only form micellar structures between each other so that no effect of addition by an increase in amount may be expected.

Examples of dispersion stabilizers are described below, but the present invention is not limited thereto. Examples may include low-molecular weight compounds such as alkylamines and sugar alcohols and water-soluble macromolecules having a weight average molecular weight of 10,000 to 50,000,000 that form hydrogen bonds, such as glycerol, higher alcohols, polyvinyl alcohol and κ-carrageenan.

Examples of the water-soluble macromolecules described above may include alginic acid, propylene glycol alginate, gum arabic, xanthan gum, hyaluronic acid, chondroitin sulfate, cellulose acetate, hydroxymethyl cellulose, methyl cellulose, hydroxypropyl methyl cellulose, chitosan, chitin, gelatin, collagen and polyoxyethylene-polyoxypropylene block copolymer.

The content of dispersion stabilizers in the aqueous dispersion of fine carbon fibers according to the present invention is in the range of 0.001 to 50% by mass, preferably in the range of 0.005 to 40% by mass, and more preferably in the range of 0.01 to 30% by mass. Thus, when the fine carbon fibers are less than 0.001% by mass, desired dispersed state may not easily be obtained. Also, when the dispersion stabilizers are more than 50% by mass, desired electrical conductivity may not be obtained.

Typical dispersion machines are used as dispersion machines for producing the aqueous dispersion of fine carbon fibers according to the present invention. Examples may include bead mills (DYNO-MILL, Shinmaru Enterprises Corporation), TK Labodisper, TK Filmix, TK Pipline Mixer, TK Homomic Line mills, TK Homo Jetter, TK Unimixer, TK Homomic Line Flow, TK Agi Homo Disper (Tokushukikakogyo K. K.), homogenizer POLYTRON (Central Scientific Commerce, Inc.), homogenizer Physcotron (Nition Irika Kikai Seisakusho Co., Ltd.), Bio Mixer (Nihon Seiki Kaisha Ltd.), Turbo Type Agitator (Kodaira Seisakusho Co., Ltd.), Ultradispa (Asada Iron Works, Co. Ltd.), Ebaramilder (Ebara Corporation) and ultrasonic devices or ultrasonic cleaners (As One Corporation).

The planar heating element according to the prevent invention is preferably produced through the steps of application, forming a heating layer, forming electrodes, and forming an insulating layer in the mentioned order. Alternatively, when an insulating substrate in which electrodes are preformed, they can be produced through the steps of application, forming a heating layer, and forming an insulating layer in the mentioned order. Further, when electrodes are formed in a heating layer, they can be produced through the steps of application, forming a heating layer, forming electrodes, application, forming a heating layer, forming an insulating layer and the like. In producing the planar heating element according to the present invention, therefore, electrodes may be disposed directly on an insulating substrate so that electrically conductive layers can be formed on the upper side and peripheries of the electrodes. Thus, distances between the electrodes and/or heat generation may easily be controlled.

Typical methods for application may be adopted as methods for applying aqueous dispersions of fine carbon fibers to insulating substrates. Examples of methods for application are mentioned below, but the present invention is not limited thereto. Examples may include dropping, dipping, screen printing, air spray coating, airless spray coating, low-pressure atomized spray coating, coating by bar coding and coating with spin coaters.

A step of forming a heating layer means a step of drying after applying an aqueous dispersion of fine carbon fibers to a substrate by any of the methods described above, in which the coated film may be dried at an ordinary temperature. In order to fully dry the coated film, a drying temperature should be preferably at 10 to 500° C., more preferably at 50 to 250° C. and particularly preferably at 70 to 100° C. When the drying temperature is lower than 10° C., drying may not sufficiently proceed; while the drying temperature is higher than 500° C., the insulating substrate may be deformed depending on the material. Drying time may be determined, depending on the area of a planar heating element and the drying temperature.

During the step of forming electrodes, electrodes may be formed in the insulating substrate, in the planar heating layer and over the planar heating layer, using a typical material for electrodes. A typical step for forming can also be used as a step of forming an insulating layer.

Substrates for the present planar heating element are preferably insulating, and ceramics, glasses, gums, thermosetting resins, thermoplastic resins, woods, papers, leathers, bamboos and the like can be used.

The present planar heating element may be structured with flat or curved surfaces and may be disposed on a flexible material.

The thickness of the planar heating element is not particularly limited, and is preferably 0.4 mm or smaller, more preferably 0.2 mm or smaller and even more preferably 0.1 mm or smaller. The lower limit is not particularly defined and is 0.01 mm or greater, for example.

The electrical resistance between electrodes is not particularly limited, and is preferably 300Ω or smaller, more preferably 200Ω or smaller and even more preferably 100Ω or smaller. The lower limit is not particularly defined and is 2Ω or greater, for example.

By coating the heating layer, the life time of the planar heating element may be lengthened. Also, delamination or the like of the fine carbon fibers can be avoided. The power source may be of alternating current (AC) or direct current (DC).

### EXAMPLES

Examples are presented below to specifically describe the present invention, but the present invention is not limited thereto.

### Production Example 1

The fine carbon fibers used for the present invention were synthesized as follows.

Carbon fibers were synthesized according to a CVD method, using toluene as the raw material.

A mixture of ferrocene and thiophene was used as a catalyst and the mass ratio between the catalyst and the carbon in the raw material was 150:1, the gas feed rate into the reactor was 1300 NL/min and the pressure was 1.03 atm. Synthesis reaction was carried out in a reducing atmosphere of hydrogen gas. The toluene, the catalyst and the hydrogen gas were heated to 380° C., fed to a generation furnace and decomposed at 1250° C. to obtain carbon fiber structures (first intermediate). The outer diameter distribution of the carbon fiber structures was 40 nm at minimum and 90 nm at maximum with an average of 70 nm. The synthesized intermediate was fired at 900° C. in nitrogen to separate off hydrocarbons such as tar to obtain a second intermediate. The second intermediate showed an R value of 0.98 as determined by Raman spectroscopy. Also, the first intermediate was dispersed in toluene to prepare samples for electron microscopy. Observed SEM and TEM photographs are shown in FIGS. 3 and 4.

Further, the second intermediate was heat-treated at an elevated temperature of 2600° C. in argon and the obtained aggregates of carbon fiber structures were pulverized through an air flow pulverizer to obtain carbon fiber structures according to the present invention.

The obtained carbon fiber structures were dispersed in toluene by an ultrasonic wave to prepare samples for electron microscopy. Observed SEM and TEM photographs are shown in FIGS. 5 and 6.

Also, the obtained carbon fiber structures were directly placed in a sample holder for electron microscopy. An observed SEM photograph and the particle size distribution are shown in FIG. 7 and Table 1, respectively.

TABLE 1

| Particle size distribution (number) | Example |
|---|---|
| Smaller than 30 μm | 31 |
| 30 μm to smaller than 40 μm | 214 |
| 40 μm to smaller than 50 μm | 258 |
| 50 μm to smaller than 60 μm | 202 |
| 60 μm to smaller than 70 μm | 106 |
| 70 μm to smaller than 80 μm | 42 |
| 80 μm to smaller than 90 μm | 23 |
| 90 μm to smaller than 100 μm | 12 |
| 100 μm or larger | 11 |
| Circle-equivalent average diameter | 45.8 μm |

Further, before and after the heat treatment at an elevated temperature, X-ray diffraction and Raman spectroscopy were carried out on the carbon fiber structures to investigate any changes. The results are shown in FIGS. 8 and 9.

Also, the obtained carbon fiber structures had a circle-equivalent average diameter of 45.8 μm, a bulk density of 0.0057 g/cm³, a Raman I_{D}/I_{G} ratio of 0.094, a TG combustion temperature of 832° C., a spacing of lattice planes of 3.384 angstroms, a powder resistance of 0.0122 Ω·cm and a density after restoration of 0.18 g/cm³.

The various parameters relating to the carbon fiber structures were determined according to the methods to be described below.

Circle-Equivalent Average Diameter Based on Area

First, photographs of carbon fiber structures are taken by SEM. In the SEM photographs taken, carbon fiber structures whose profiles were clear were selected, while collapsed carbon fiber structures whose profiles were not clear were not. All the carbon fiber structures captured in one field of view (approximately 60 to 80) were used so that approximately 200 carbon fiber structures in three fields of view were selected.

Profiles of the selected carbon fiber structure were traced using an image analysis software Win Roof (tradename, MITANI Corporation), areas within the profiles were given and circle-equivalent diameters of the fiber structures were calculated and averaged.

Bulk Density Measurement

One g of powder is filled in a transparent cylinder 70 mm in inner diameter and having dispersion plates and 1.3 liter of air is fed at a pressure of 0.1 Mpa through lower portions of the dispersion plates to blow the powder out and let it naturally sediment. After five blowouts, the height of the powder layer after sedimentation is measured. Measurements were taken at six points and averaged to calculate a bulk density.

Raman Spectroscopy

Measurements were taken using LabRam 800 produced by Horiba Jobin Yvon, Inc. with a wavelength of argon laser at 514 nm.

TG Combustion Temperature

Using TG-DTA produced by MAC Science Co., Ltd., combustion behaviors were measured as temperatures were raised at 10° C./min while flowing air at a flux of 0.1 L/min. During combustion, TG shows a decrease in amount and DTA shows an exothermic peak and, therefore, the top position of the exothermic peak was defined as combustion start temperature.

X-Ray Diffraction

Using powder X-ray diffraction instrument (JDX 3532, JEOL Ltd.) carbon fiber structures after annealing were investigated. A K α line generated by a Cu tube at 40 kV and 30 mA was used and spacings of lattice planes were measured according to the Gakushin method (The Latest Carbon Material Experimental Techniques-Analysis, The Carbon Society of Japan) using silicone powder as internal standard.

Powder Resistance and Restoration

1.0 g of powder of carbon fiber structures was weighed and press-loaded into a resinous die (inner dimensions, 40 L, 10 W, 80H mm) and displacement and loading are read. A constant current was applied by the four-terminal method, during which voltages were measured. After measuring until the density reached 0.9 g/cm³, the pressure was released and density after restoration was measured. Powder resistances are to be measured when the powder was compressed to 0.5, 0.8 and 0.9 g/cm³.

The various physical properties measured in Example are summarized in Table 2.

TABLE 2

| Physical properties | Example |
|---|---|
| Circle-equivalent diameter (μm) | 45.8 |
| Bulk density (g/cm³) | 0.0057 |
| ID/IG ratio (—) | 0.094 |
| TG combustion temperature (° C.) | 832 |
| (022) spacing (A) | 3.384 |
| Powder resistance (at 0.5 g/cm³) | 0.1390 (Ω · cm) |
| Powder resistance (at 0.8 g/cm³) | 0.0122 (Ω · cm) |
| Powder resistance (at 0.9 g/cm³) | 0.0104 (Ω · cm) |
| Density after restoration (g/cm³) | 0.18 |

### Example 1

### (1) Preparation of Aqueous Dispersion of Carbon Nanotubes

To 500 g of deionized water in which 1 g of 3-(N,N-dimethylmyristylammonio)propanesulfonate as an amphlytric surfactant and 2 g of, κ-carrageenan were dissolved, 5 g of the carbon fiber structures of Production Example 1 (Nano Carbon Technologies Co., Ltd., MWNT-7 (multi-layer carbon nanotubes with fiber outer diameter of 40 to 90 nm)) were introduced and agitated for one hour. This aqueous solution was subjected to bead mill dispersion to obtain an aqueous dispersion of carbon nanotubes.

### (2) Production of Electrically Conductive Carbon Nanotube Film

An insulating substrate made of a polycarbonate resin (Panlite L-1225, Teijin Chemicals Ltd.) 3 mm in thickness cut to a width of 190 mm and a length of 270 mm was laminated with a substrate of the same size with a cutout in the center 160 mm in width and 240 mm in length to fabricate a substrate. To the recess at the center, 35 ml of an aqueous dispersion of carbon nanotubes was dropped and dried at 80° C. for 60 minutes to fabricate an electrically conductive carbon nanotube film as a planar heating layer. The planar heating layer had a width of 160 mm, a length of 240 mm and a thickness of 42 μm.

### (3) Fabrication of Electrodes

Sliver paste 5 mm in width was applied at each end of the 160 mm width of the planar heating layer described above, over which a cupper plate 4 mm in width, 160 mm in length and 1 mm in thickness cut to a T shape was disposed, over which silver past was applied again to fix the copper plate electrode.

### (4) Fabrication of Insulating Layer for Coating

An insulating substrate made of a polycarbonate resin 2 mm in thickness cut to a width of 155 mm and a length of 239 mm was disposed and fixed on the planar heating layer, over which a further insulating substrate 3 mm in thickness cut to a width of 190 mm and a length of 270 mm was adhered and fixed to fabricate a planar heating element.

### (5) Evaluation of Planar Heating Element

The resistance between electrodes was measured using a DIGITAL MULTTIMETER(CUSTOM, CDM-17 D) and the on-surface temperature of the planar heating element was measured using a radiation thermometer (TASCO, THI-44 NH). For measurement of planar heating temperature, when the on-surface temperature was 100° C. or higher, no measurements were taken at or higher than the applied voltage. Current values of the planar heating element were measured using an amperometer DIGITAL MULTTIMETER(CUSTOM, CDM-17 D) wired in series with the planar heating element. For evaluation of heating characteristics of the planar heating element, applied voltages were transformed at AC 5, 10, 20, 25 and 30 V using a variable voltage controller (YAMABISHI ELECTRIC CO., LTD. S-130-10) and on-surface temperatures 15 minutes after each transformation were measured using a radiation thermometer. These measurements were taken in a thermo-hygrostat chamber (room temperature 23° C., humidity 27%). The results are shown in Table 3.

### Example 2

A planar heating element was fabricated in a similar manner to Example 1, except that the planar heating layer was 40 mm in width, 40 mm in length and 57 μm in thickness and the electrode was disposed at each end of the 40 mm width of the planar heating layer. The results are shown in Table 4.

### Example 3

A planar heating element was fabricated in a similar manner to Example 1, except that the planar heating layer was 40 mm in width, 80 mm in length and 60 μm in thickness and the electrode was disposed at each end of the 40 mm width of the planar heating layer. The results are shown in Table 5.

### Example 4

A planar heating element was fabricated in a similar manner to Example 1, except that the planar heating layer was 40 mm in width, 120 mm in length and 66 μm in thickness and the electrode was disposed at each end of the 40 mm width. The results are shown in Table 6.

### Example 5

A planar heating element was fabricated in a similar manner to Example 1, except that the added amount of the multi-layer carbon nanotubes was 10 g. The planar heating layer was 160 mm in width, 240 mm in length and 47 μm in thickness. The results are shown in Table 7.

### Example 6

A planar heating element was fabricated in a similar manner to Example 1, except that the added amount of the multi-layer carbon nanotubes was 25 g. The planar heating layer was 160 mm in width, 240 mm in length and 83 μm in thickness. The results of its heating characteristics are shown in Table 8.

### Example 7

### (6) Surface Temperature Change of Planar Heating Element

Using the planar heating element fabricated in Example 1, change in surface temperature at the center of the planar heating element when a DC voltage of 24 V was applied was measured by a radiation thermometer 5, 10, 15, 30, 45, 60, 75 and 90 minutes after each application. The results are shown in FIG. 1.

### Example 8

### (7) On-Surface Temperature Uniformity of Planar Heating Element

Using the planar heating element fabricated in Example 1, on-surface temperatures of 11 portions shown in FIG. 2 of the planar heating element 90 minutes after application of a DC voltage of 24 V were measured to determine on-surface temperature uniformity. The results are shown in Table 9.

### Comparative Example 1

A planar heating element was fabricated in a similar manner to Example 1, except that the multi-layer carbon nanotubes were replaced with Ketjen Black (Lion Corporation, EC 600 JD). The planar heating layer was 160 mm in width, 240 mm in length and 41 μm in thickness. The results are shown in Table 10.

### Comparative Example 2

A planar heating element was fabricated in a similar manner to Example 1, except that the multi-layer carbon nanotubes were replaced with Denka Black (Denki Kagaku Kogyo Kabushiki Kaisha, HS-100). The planar heating layer was 160 mm in width, 240 mm in length and 43 μm in thickness. The results are shown in Table 11.

### Comparative Example 3

Using the Ketjen Black film fabricated in Comparative Example 1, change in surface temperature at the center of the planar heating element was measured. The results of on-surface temperature uniformity are shown in FIG. 1.

TABLE 3

| | | | | | | | Res. between |
|---|---|---|---|---|---|---|---|
| | Applied voltages (V) | | | | | | electrodes |
| Example 1 | 5 V | 10 V | 15 V | 20 V | 25 V | 30 V | (Ω) |
| On-surface | 25 | 29 | 36 | 51 | 67 | 78 | 31 |
| temp.(° C.) | | | | | | | |
| Current | 0.14 | 0.38 | 0.57 | 0.78 | 0.95 | 1.17 | |
| (A) | | | | | | | |

TABLE 4

| | Applied voltage (V) | Res. between |
|---|---|---|
| Example 2 | 5 V | electrodes (Ω) |
| On-surface temp.(° C.) | 122 | 5.4 |
| Current (A) | 1.0 | |

TABLE 5

| | Applied voltages (V) | | Res. between |
|---|---|---|---|
| Example 3 | 5 V | 10 V | electrodes (Ω) |
| On-surface temp.(° C.) | 49 | 116 | 11 |
| Current (A) | 0.4 | 0.9 | |

TABLE 6

| | Applied voltages (V) | | | Res. between |
|---|---|---|---|---|
| Example 4 | 5 V | 10 V | 15 V | electrodes (Ω) |
| On-surface temp.(° C.) | 40 | 84 | 146 | 15 |
| Current (A) | 0.3 | 0.7 | 1.0 | |

TABLE 7

| | | | | | | | Res. between |
|---|---|---|---|---|---|---|---|
| | Applied voltages (V) | | | | | | electrodes |
| Example 5 | 5 V | 10 V | 15 V | 20 V | 25 V | 30 V | (Ω) |
| On-surface | 24 | 27 | 31 | 38 | 47 | 62 | 38 |
| temp.(° C.) | | | | | | | |
| Current | 0.11 | 0.24 | 0.36 | 0.51 | 0.64 | 0.79 | |
| (A) | | | | | | | |

TABLE 8

| | | | | | | | Res. between |
|---|---|---|---|---|---|---|---|
| | Applied voltages (V) | | | | | | electrodes |
| Example 6 | 5 V | 10 V | 15 V | 20 V | 25 V | 30 V | (Ω) |
| On-surface | 25 | 30 | 37 | 50 | 67 | 82 | 21 |
| temp.(° C.) | | | | | | | |
| Current | 0.21 | 0.43 | 0.65 | 0.92 | 1.15 | 1.4 | |
| (A) | | | | | | | |

TABLE 9

| | Portions of measurement for on-surface | | | | | | | | | | |
|---|---|---|---|---|---|---|---|---|---|---|---|
| | temperature of planar heating element | | | | | | | | | | |
| Example 8 | 1 | 2 | 3 | 4 | 5 | 6 | 7 | 8 | 9 | 10 | 11 |
| On-surface | 54 | 53 | 52 | 55 | 56 | 55 | 56 | 56 | 56 | 55 | 55 |
| temp.(° C.) | | | | | | | | | | | |

TABLE 10

| | | | | | | | Res. between |
|---|---|---|---|---|---|---|---|
| Comparative | Applied voltages (V) | | | | | | electrodes |
| Example 1 | 5 V | 10 V | 15 V | 20 V | 25 V | 30 V | (Ω) |
| On-surface | 25 | 25 | 25 | 25 | 25 | 25 | 1330 |
| temp.(° C.) | | | | | | | |
| Current | 0 | 0 | 0 | 0 | 0 | 0 | |
| (A) | | | | | | | |

TABLE 11

| | | | | | | | Res. between |
|---|---|---|---|---|---|---|---|
| Comparative | Applied voltages (V) | | | | | | electrodes |
| Example 2 | 5 V | 10 V | 15 V | 20 V | 25 V | 30 V | (Ω) |
| On-surface | 23 | 23 | 23 | 23 | 23 | 23 | 5150 |
| temp.(° C.) | | | | | | | |
| Current | 0 | 0 | 0 | 0 | 0 | 0 | |
| (A) | | | | | | | |

It is apparent from Examples 1 to 8 and Comparative Examples 1 and 2 that the planar heating elements having excellent planar heating characteristics were attained by the use of the fine carbon fibers having low powder resistivity instead of carbon black whose powder resistivity is higher as the electrically conductive material to be used for the heating layer of the present planar heating element.

It is understood from Examples 1 to 6 that the present planar heating elements do not exhibit PTC characteristics because there can be no great difference between calculated resistances between electrodes in conditions where the on-surface temperature is increased.

It is understood from Example 7 that the present planar heating element is an excellent planar heating element that is quick in exothermic response and exhibits no temperature increase even with the passage of time. On the contrary, it is understood that the planar heating elements of Comparative Examples 1 and 2 do not allow electric current to flow even at an applied voltage of 30 V with no heat generation.

It is understood from Example 8 that the present planar heating element is a planar heating element having high temperature uniformity.

### INDUSTRIAL APPLICABILITY

Use of the aqueous dispersion of fine carbon fibers according to the present invention enables to obtain electrically conductive fine carbon fiber films which develop planar heating effects. As such, they can be used as heating sources for electric carpets, floor heating, wall surface heating appliances, heaters for thawing on roads and/or roofs or antifogging for mirrors or heaters to be used for heating and/or insulation of pipelines and the like.

### BRIEF DESCRIPTION OF THE DRAWINGS

FIG. 1 is a graph showing changes with time in on-surface temperatures of planar heating elements in Example 7 and Comparative Example 3.

FIG. 2 is a drawing illustrating locations where measurements for temperature uniformity were carried out on the planar heating element in Example 8.

FIG. 3 is an SEM photograph of a first intermediate of carbon fiber structures according to the present invention.

FIG. 4 is a TEM photograph of a first intermediate of carbon fiber structures according to the present invention.

FIG. 5 is an SEM photograph of carbon fiber structures according to the present invention.

FIG. 6 is a TEM photograph of carbon fiber structures according to the present invention.

FIG. 7 is an SEM photograph of carbon fiber structures according to the present invention.

FIG. 8 is an X-ray diffraction chart of carbon fiber structures according to the present invention and an intermediate of the carbon fiber structures.

FIG. 9 is a Raman spectroscopy chart of carbon fiber structures according to the present invention and an intermediate of the carbon fiber structures.

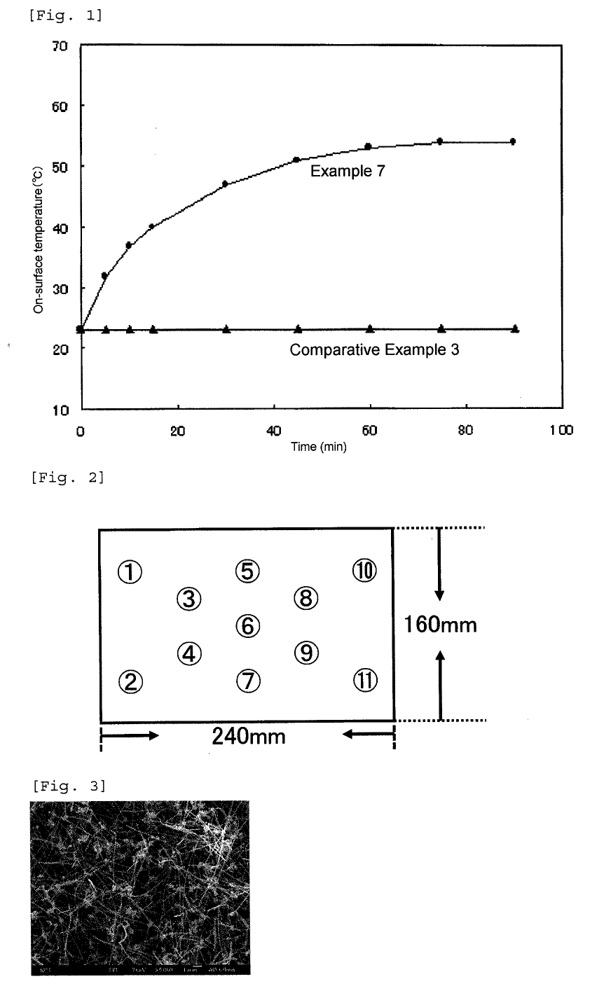

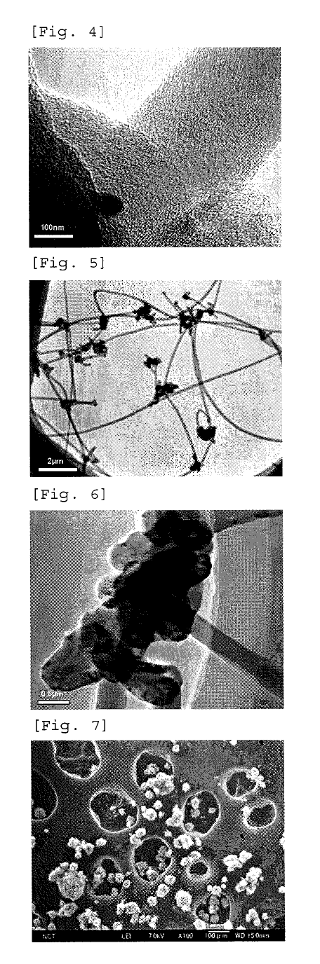

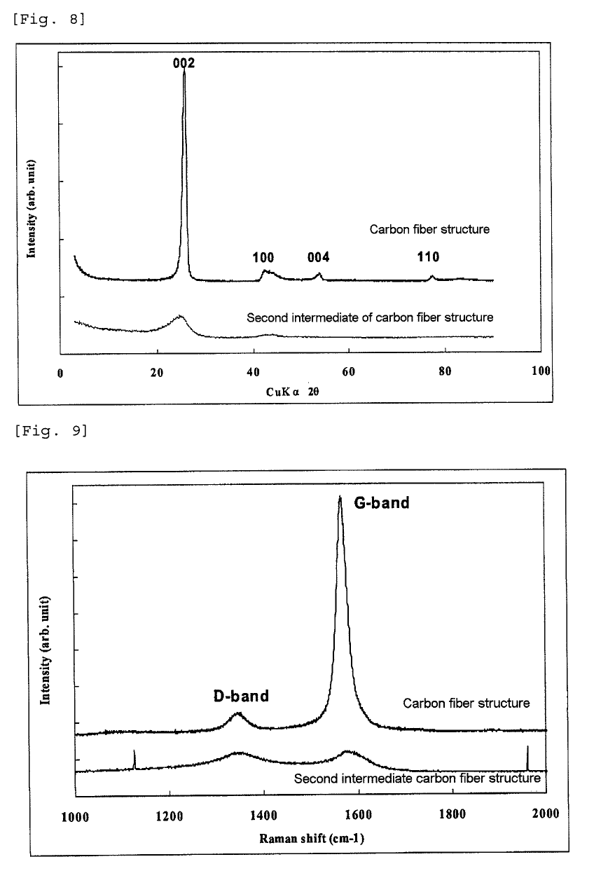

1. A planar heating element obtained using an aqueous dispersion of fine carbon fibers.

2. The planar heating element according to claim 1, obtained by applying the aqueous dispersion of fine carbon fibers to a substrate surface and drying the dispersion.

3. The planar heating element according to claim 1 or 2, wherein the aqueous dispersion of fine carbon fibers contains an ampholytic surfactant.

4. The planar heating element according to any one of claims 1 to 3, wherein the aqueous dispersion of fine carbon fibers contains an ampholytic surfactant and a dispersion stabilizer added thereto.

5. The planar heating element according to any one of claims 1 to 4, wherein the ampholytic surfactant contains an ampholytic hydrophillic group of a sulfobetaine skeleton.

6. The planar heating element according to any one of claims 1 to 5, wherein the ampholytic surfactant is one or more selected from 3-(N,N-dimethylstearylammonio)propanesulfonate, 3-(N,N-dimethylmyristylammonio)propanesulfonate, 3-[(3-cholamidepropyl)dimethylammonio]-2-hydroxypropanesulfonate, n-hexadecyl-N and N′-dimethyl-3-ammonio-1-propanesulfonate.

7. The planar heating element according to claim 4, wherein the dispersion stabilizer is one or more selected from a low-molecular weight compound having an amino group or a hydroxyl group, an oligomer having an amino group or a hydroxyl group, and a water-soluble macromolecule having an amino group or a hydroxyl group.

8. The planar heating element according to claim 7, wherein the dispersion stabilizer is a sugar alcohol, glycerol, a higher alcohol or polyvinyl alcohol.

9. The planar heating element according to any one of claims 1 to 8, wherein the fine carbon fibers are composed of fine carbon fibers having an outer diameter of 0.5 to 800 nm.

10. The planar heating element according to any one of claims 1 to 9, wherein the fine carbon fibers are single-layer, two-layer, three-layer or multilayer carbon nanotubes.

11. The planar heating element according to any one of claims 1 to 10, wherein the fine carbon fibers are networked carbon nanotube structures composed of carbon nanotubes having an outer diameter of 15 to 100 nm, the carbon nanotube structures being embodied as the carbon nanotubes extending in plurality, having granular portions for linking the carbon nanotubes with each other, the granular portions formed in the process of carbon nanotube growth, having a size 1.3 times or more as large as the outer diameter of the carbon nanotubes and having an I_{D}/I_{G} of 0.1 or smaller as determined by Raman spectroscopy at 514 nm.

12. The planar heating element according to any one of claims 1 to 11, wherein the multilayer carbon nanotubes used are high in purity having a tar content of 0.5% or less.

13. The planar heating element according to any one of claims 1 to 12, wherein the aqueous dispersion of fine carbon fiber contains the carbon nanotubes at a mass ratio of 0.01 to 30%.

14. The planar heating element according to any one of claims 1 to 13, wherein an electrically conductive fine carbon fiber film obtained using the aqueous dispersion of fine carbon fibers constitutes a planar heating layer.

15. The planar heating element according to any one of claims 1 to 14, wherein the planar heating layer has a film thickness of 0.4 mm or smaller.

16. The planar heating element according to any one of claims 1 to 15, wherein the planar heating layer has a resistance between electrodes of 300Ω or lower.

17. The planar heating element according to any one of claims 1 to 16, wherein the electrodes are provided only at the both ends of the planar heating layer.

18. The planar heating element according to any one of claims 1 to 17, wherein the planar heating layer does not exhibit PTC characteristics.

19. The planar heating element according to any one of claims 1 to 18, composed of an electrically conductive fine carbon fiber film obtained using an aqueous dispersion of fine carbon fibers on an insulating substrate and electrodes.

20. The planar heating element according to any one of claims 1 to 19, composed of an electrically conductive fine carbon fiber films obtained using an aqueous dispersion of fine carbon fibers on an insulating substrate, electrodes and an insulating substrate coating the electrodes.

21. A process for producing planar heating elements, comprising an application step of applying an aqueous dispersion of fine carbon fibers to a surface of an insulating substrate, a planar heating layer forming step of drying the aqueous dispersion of fine carbon fibers applied on the insulating substrate to form a planar heating layer, and an electrode forming step of forming electrodes on the planar heating layer.

22. The process for producing planar heating elements according to claim 21, comprising an application step of applying an aqueous dispersion of fine carbon fibers to a surface of an insulating substrate, a planar heating layer forming step of drying the aqueous dispersion of fine carbon fibers applied on the insulating substrate to form a planar heating layer, an electrode forming step of forming electrodes on the planar heating layer, and an insulating layer forming step of coating the heating layer and the electrodes.
